(19) United States
(12) Patent Application Publication
(10) Pub. No.: US 2026/0352536 A1
(43) Pub. Date: Nov. 5, 2026

(54) TRANSMITTING APPARATUS, RECEIVING APPARATUS, AND COMMUNICATION SYSTEM

(71) Applicant: Mitsubishi Electric Corporation, Tokyo (JP)

(72) Inventors: Hiroshi NISHIMOTO, Tokyo (JP); Akinori OHASHI, Tokyo (JP); Akinori NAKAJIMA, Tokyo (JP)

(73) Assignee: Mitsubishi Electric Corporation, Tokyo (JP)

(21) Appl. No.: 19/734,203

(22) Filed: Jul. 8, 2026

Related U.S. Application Data
(63) Continuation of application No. PCT/JP2024/003322, filed on Feb. 1, 2024.

(51) Int. Cl. H04L 27/26

(52) U.S. Cl. CPC H04L 27/261; H04L 27/2653

(57) ABSTRACT

A transmitting apparatus that performs Orthogonal Frequency Division Multiplexing communication includes a subcarrier mapping unit that replicates a subcarrier signal sequence and maps a plurality of the replicated subcarrier signal sequences at equal intervals with a subcarrier spacing, and a transmission phase rotation unit that divides each subcarrier signal sequence mapped with the subcarrier spacing into two or more subsets and applies a phase rotation that results in a different time timing to each subset.

### CROSS-REFERENCE TO RELATED APPLICATION

This application is a continuation application of International Application PCT/JP2024/003322, filed on Feb. 1, 2024, and designating the U.S., the entire contents of which are incorporated herein by reference.

### BACKGROUND OF THE INVENTION

### 1. Field of the Invention

The present disclosure relates to a transmitting apparatus that performs Orthogonal Frequency Division Multiplexing (OFDM) communication, a receiving apparatus, and a communication system.

### 2. Description of the Related Art

OFDM communication adopted in wireless local area networks (LANs) and the like is a transmission scheme that is robust to multipath delay and enables a wider band. However, in the case where the frequency selectivity of a transmission path results in a drop in communication quality in the transmission path, or in the case where non-negligible interference is superimposed on a reception signal within a signal band, for example, degradation of reception quality is feared. As a measure against a case where frequency-selective fading causes a deep drop in communication quality in a transmission path, frequency diversity transmission has been studied in which the same signal is transmitted on a plurality of subcarriers. In the case where a transmission and reception system is an open-loop system, frequency diversity transmission is an optimum transmission scheme in which a transmitting apparatus replicates and maps subcarrier signal sequences at equal intervals for transmission against a drop in communication quality in an unknown transmission path. Such a transmission scheme is hereinafter referred to as frequency repetition.

In frequency repetition, for example, a subcarrier signal sequence with a length L is replicated M times, and the M replicated subcarrier signal sequences are distributed and mapped at equal intervals with a subcarrier spacing D. The application of frequency repetition allows improvements in a drop in communication quality in a transmission path, in resistance to interference, and the like described above. However, frequency repetition, in which the same signal is replicated and mapped onto a plurality of subcarriers, disadvantageously leads to degradation of the peak-to-average power ratio (PAPR) that is the peak-to-average power ratio of a transmission waveform on which the inverse discrete Fourier transform has been performed, and a reduction in transmission power efficiency. For measures against peaks of a transmission waveform in a transmitting apparatus, various studies have been made. For example, Japanese Patent No. 4905463 discloses a technique for a radio communication apparatus capable of securing signal quality while maintaining the high efficiency of an amplifier even when modulation schemes adaptively change.

However, the above conventional technique relates to a typical measure against peaks of a transmission waveform, and disadvantageously neither discloses nor suggests a measure against peaks of a transmission waveform specific to frequency repetition.

### SUMMARY OF THE INVENTION

In order to solve the above-described problems and achieve the object, the present disclosure provides a transmitting apparatus that performs Orthogonal Frequency Division Multiplexing communication. The transmitting apparatus comprises: a subcarrier mapping unit to replicate a subcarrier signal sequence and map a plurality of the replicated subcarrier signal sequences at equal intervals with a subcarrier spacing; and a transmission phase rotation unit to divide each of the subcarrier signal sequences mapped with the subcarrier spacing into two or more subsets and apply a phase rotation that results in a different time timing to each of the subsets.

### BRIEF DESCRIPTION OF THE DRAWINGS

FIG. 1 is a diagram illustrating an exemplary configuration of a communication system according to a first embodiment;

FIG. 2 is a flowchart illustrating an operation of a transmitting apparatus according to the first embodiment;

FIG. 3 is a flowchart illustrating an operation of a receiving apparatus according to the first embodiment;

FIG. 4 is a diagram illustrating an example of the signal waveform of subcarrier signal sequences and the signal waveform of time signal blocks that have been converted with the inverse discrete Fourier transform (IDFT) obtained by a transmitting apparatus that does not perform phase rotation as a comparative example;

FIG. 5 is a diagram illustrating an example of the signal waveform of subcarrier signal sequences and the signal waveform of time signal blocks that have been converted with the IDFT obtained by the transmitting apparatus of the communication system according to the first embodiment;

FIG. 6 is a diagram illustrating an example of the complementary cumulative distribution function characteristics of instantaneous normalized signal power obtained by the communication system according to the first embodiment;

FIG. 7 is a diagram illustrating an exemplary configuration of processing circuitry in the case where a processor and a memory constitute processing circuitry that implements the transmitting apparatus according to the first embodiment;

FIG. 8 is a diagram illustrating an example of processing circuitry in the case where dedicated hardware constitutes processing circuitry that implements the transmitting apparatus according to the first embodiment; and

FIG. 9 is a diagram illustrating an exemplary configuration of a communication system according to a second embodiment.

### DETAILED DESCRIPTION OF THE PREFERRED EMBODIMENTS

Hereinafter, a transmitting apparatus, a receiving apparatus, and a communication system according to embodiments of the present disclosure will be described in detail with reference to the drawings.

### First Embodiment

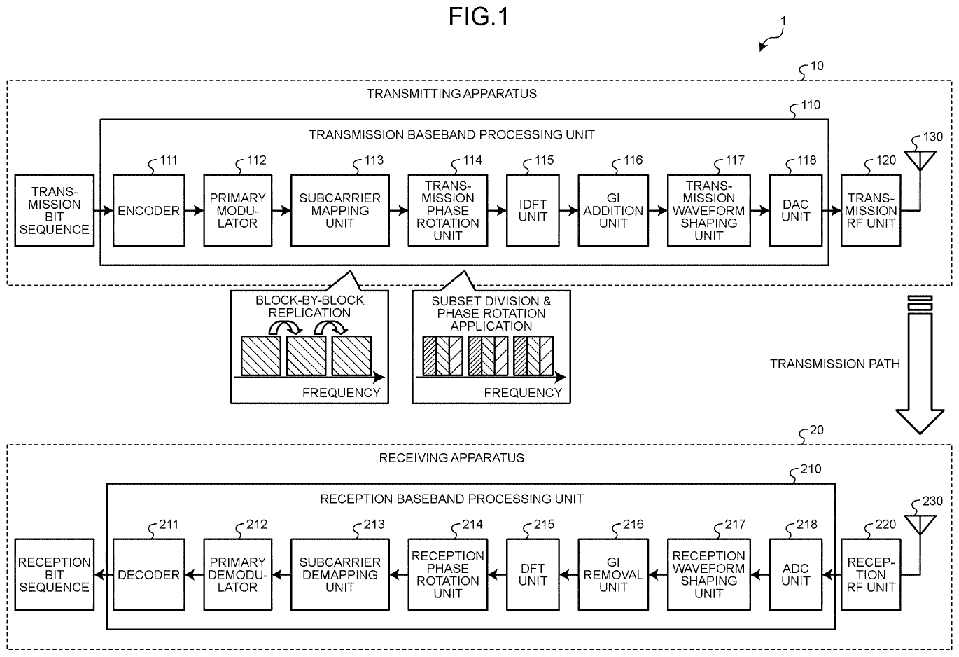

FIG. 1 is a diagram illustrating an exemplary configuration of a communication system 1 according to a first embodiment. The communication system 1 includes a transmitting apparatus 10 and a receiving apparatus 20. The communication system 1 is a system in which the transmitting apparatus 10 and the receiving apparatus 20 perform wireless communication using OFDM communication to which frequency repetition is applied. In the following description, OFDM communication is sometimes referred to as Orthogonal Frequency Division Multiplexing communication. Although FIG. 1 illustrates an example in which the communication system 1 includes the single transmitting apparatus 10 and the single receiving apparatus 20, which is not limiting. The communication system 1 may include a plurality of the transmitting apparatuses 10 and a plurality of the receiving apparatuses 20.

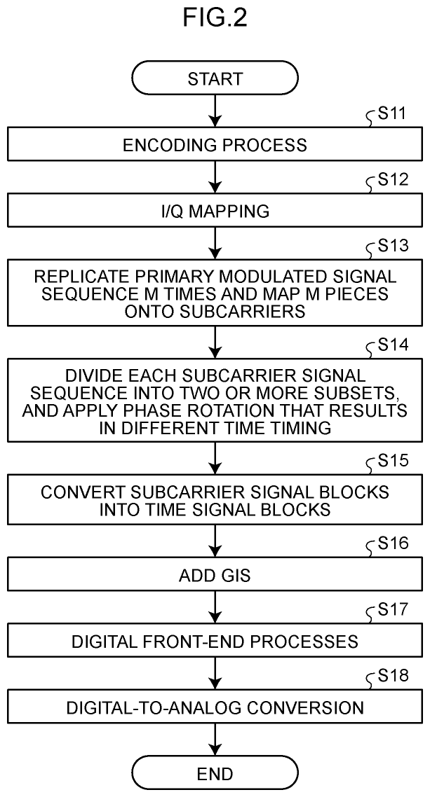

The transmitting apparatus 10 includes a transmission baseband processing unit 110 that generates a baseband signal from a transmission bit sequence, a transmission radio frequency (RF) unit 120 that converts the baseband signal generated by the transmission baseband processing unit 110 into a radio-frequency signal, and a transmitting antenna 130 that transmits the radio-frequency signal converted by the transmission RF unit 120. The transmission baseband processing unit 110 includes an encoder 111, a primary modulator 112, a subcarrier mapping unit 113, a transmission phase rotation unit 114, an IDFT unit 115, a guard interval (GI) addition unit 116, a transmission waveform shaping unit 117, and a digital-to-analog conversion (DAC) unit 118. FIG. 2 is a flowchart illustrating an operation of the transmitting apparatus 10 according to the first embodiment.

The encoder 111 applies an encoding process such as error correction coding to a transmission bit sequence (step S11). The primary modulator 112 performs I/Q mapping of the transmission bit sequence encoded by the encoder 111 to a phase-shift keying (PSK)-modulated signal, a quadrature amplitude modulation (QAM)-modulated signal, or the like (step S12). The subcarrier mapping unit 113 replicates a primary modulated signal sequence with a length L M times, and maps the M pieces onto subcarriers (step S13). That is, the subcarrier mapping unit 113 replicates a subcarrier signal sequence and maps a plurality of replicated subcarrier signal sequences at equal intervals with a subcarrier spacing D. M is an integer greater than or equal to one, and D is an integer greater than or equal to one. The unit of the subcarrier spacing D is the same as the unit of the length L of the subcarrier signal sequence. Since the length of the primary modulated signal sequence, that is, the subcarrier signal sequence is L, the subcarrier spacing D is an integer satisfying DEL. The transmission phase rotation unit 114 divides each subcarrier signal sequence mapped with the subcarrier spacing D into two or more subsets, and applies a phase rotation that results in a different time timing to each subset (step S14). The detailed operation of the transmission phase rotation unit 114 will be described below.

The IDFT unit 115 converts the subcarrier signal sequences, that is, subcarrier signal blocks that have been phase-rotated by the transmission phase rotation unit 114 into time signal blocks using the IDFT (step S15). The GI addition unit 116 adds a guard interval, that is, a GI, to each time signal block (step S16). The transmission waveform shaping unit 117 performs digital front-end processes including an upsampling process, a digital filtering process, an orthogonal transformation process, and the like on the time signal blocks to which the GIs have been added (step S17). The DAC unit 118 performs digital-to-analog conversion on the time signal blocks on which the digital front-end processes have been performed (step S18), and outputs a baseband signal.

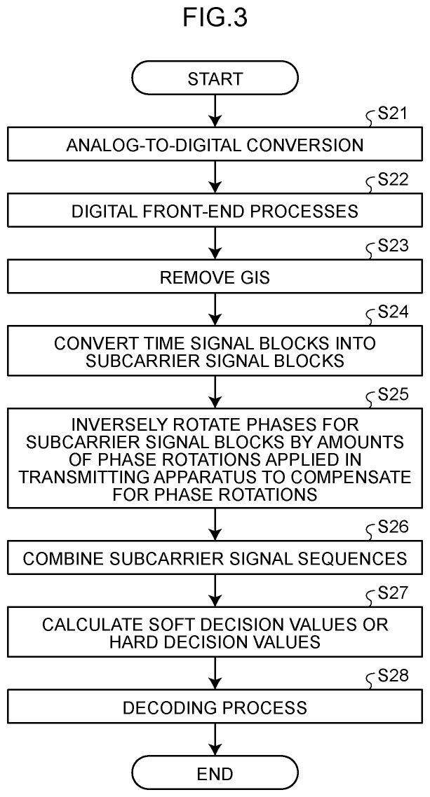

The receiving apparatus 20 receives subcarrier signal sequences transmitted from the transmitting apparatus 10 that performs OFDM communication. The receiving apparatus 20 includes a receiving antenna 230 that receives a radio-frequency signal, a reception RF unit 220 that converts the radio-frequency signal received by the receiving antenna 230 into a baseband signal, and a reception baseband processing unit 210 that generates a reception bit sequence from the baseband signal. The reception baseband processing unit 210 includes an analog-to-digital conversion (ADC) unit 218, a reception waveform shaping unit 217, a GI removal unit 216, a discrete Fourier transform (DFT) unit 215, a reception phase rotation unit 214, a subcarrier demapping unit 213, a primary demodulator 212, and a decoder 211. FIG. 3 is a flowchart illustrating an operation of the receiving apparatus 20 according to the first embodiment.

The ADC unit 218 performs analog-to-digital conversion on the baseband signal (step S21). The reception waveform shaping unit 217 performs digital front-end processes including an orthogonal demodulation process, a digital filtering process, a downsampling process, and the like on a digitally converted time signal (step S22). The GI removal unit 216 removes the GI from each time signal block on which the digital front-end processes have been performed (step S23) to extract the blocks on which to perform the DFT. The DFT unit 215 converts the time signal blocks from which the GIs have been removed into subcarrier signal blocks using the DFT (step S24).

The reception phase rotation unit 214 inversely rotates the phases for the received subcarrier signal blocks, that is, the subcarrier signal sequences by the amounts of the phase rotations applied in the transmitting apparatus 10, to compensate for the phase rotations in the transmitting apparatus 10 (step S25). The subcarrier demapping unit 213 combines the M subcarrier signal sequences replicated in the transmitting apparatus 10 (step S26) to extract the combined subcarrier signal sequences as an I/Q signal to be demodulated. That is, the subcarrier demapping unit 213 combines the subcarrier signal sequences whose phase rotations have been compensated for by the reception phase rotation unit 214, to extract the combined subcarrier signal sequences as a demodulation signal. The primary demodulator 212 performs PSK demodulation, QAM demodulation, or the like on the I/Q signal to calculate soft decision values or hard decision values (step S27). The decoder 211 performs a decoding process such as error correction decoding on the soft decision values or the hard decision values (step S28), and outputs a reception bit sequence.

Note that the inverse discrete Fourier transform, that is, the IDFT performed by the IDFT unit 115 included in the transmitting apparatus 10 includes a power-of-two-point inverse fast Fourier transform (IFFT). Likewise, the discrete Fourier transform, that is, the DFT performed by the DFT unit 215 included in the receiving apparatus 20 includes a power-of-two-point fast Fourier transform (FFT).

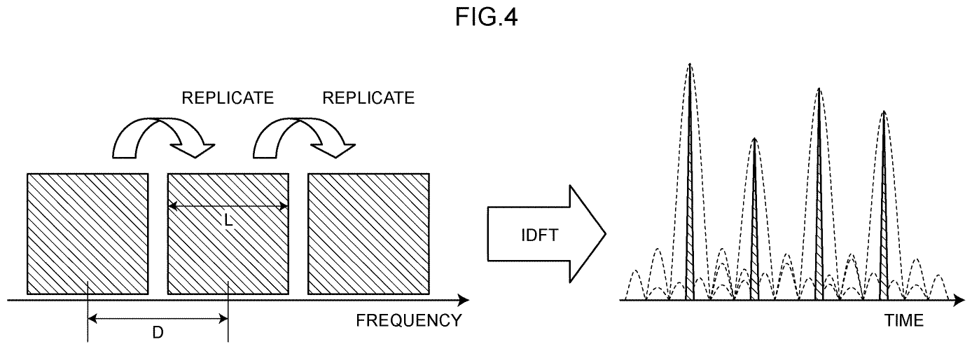

Here, before describing effects obtained by the communication system 1, that is, the transmitting apparatus 10 and the receiving apparatus 20 of the present embodiment, a problem due to conventional frequency repetition described in Background will be described with reference to a drawing. FIG. 4 is a diagram illustrating an example of the signal waveform of subcarrier signal sequences and the signal waveform of time signal blocks that have been converted with the IDFT obtained by a transmitting apparatus that does not perform phase rotation as a comparative example. The transmitting apparatus that does not perform phase rotation is, for example, a transmitting apparatus obtained by deleting the transmission phase rotation unit 114 from the transmitting apparatus 10 illustrated in FIG. 1. In FIG. 4, the left side is the signal waveform of the subcarrier signal sequences, and the right side is the signal waveform of the time signal blocks that have been converted with the IDFT. The signal waveform of the subcarrier signal sequences on the left side of FIG. 4 illustrates an example in which the number of replications of a subcarrier signal sequence is M=3, and three replicated subcarrier signal sequences with the length L are mapped onto subcarriers at equal intervals with the subcarrier spacing D.

Each subcarrier signal sequence with the length L is illustrated as one signal block continuous in frequency, but is not limited thereto. Each subcarrier signal sequence with the length L may be distributed. However, since the subcarrier signal sequences with the length L are mapped onto subcarriers at equal intervals with the subcarrier spacing D, it is required that the subcarriers for mapping do not overlap neighboring signal blocks. When an N-point IDFT is performed on the subcarrier signal sequences to which frequency repetition has been applied, in-phase combination of the M signals occurs every N/D samples, so that peaks increase, and the other time samples become nulls or side lobes. N is an integer greater than or equal to two. As described above, the application of frequency repetition disadvantageously increases the frequency of occurrence of time-waveform peaks and the magnitude of time-waveform peaks as compared with an OFDM signal to which frequency repetition is not applied, resulting in a reduction in transmission power efficiency.

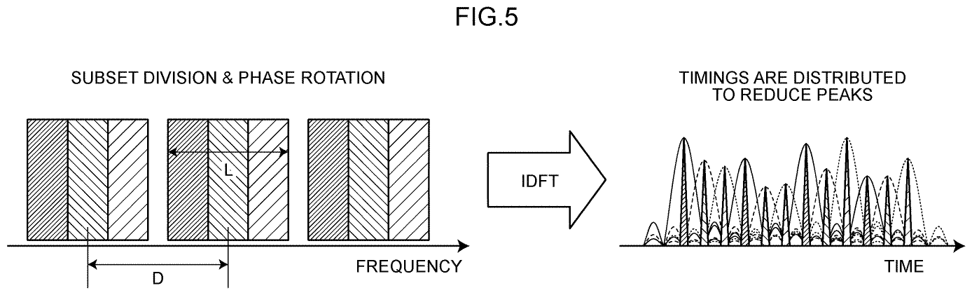

Next, a description is given of a process in the transmission phase rotation unit 114 included in the transmission baseband processing unit 110 of the transmitting apparatus 10, which is a feature of the present embodiment, in the communication system 1 to which frequency repetition is applied in the present embodiment. FIG. 5 is a diagram illustrating an example of the signal waveform of subcarrier signal sequences and the signal waveform of time signal blocks that have been converted with the IDFT obtained by the transmitting apparatus 10 of the communication system 1 according to the first embodiment. In FIG. 5, as in FIG. 4, the left side is the signal waveform of the subcarrier signal sequences, and the right side is the signal waveform of the time signal blocks that have been converted with the IDFT. The signal waveform of the subcarrier signal sequences on the left side of FIG. 5 illustrates an example in which the number of replications of a subcarrier signal sequence is M=3, and three replicated subcarrier signal sequences with the length L are mapped onto subcarriers at equal intervals with the subcarrier spacing D.

The replication mapping in the subcarrier mapping unit 113 is the same as that in the example of frequency repetition illustrated in FIG. 4. However, in the present embodiment, for the subcarrier signal sequences that have been replicated and mapped in the subcarrier mapping unit 113, the transmission phase rotation unit 114 divides each subcarrier signal sequence with the length L into K subsets. K is an integer satisfying 2≤K≤L. FIG. 5 illustrates an example in which the number of subsets is K=3. In the example of FIG. 5, each subset is illustrated as one signal block continuous in frequency, but is not limited thereto. Each subset may be a plurality of distributed subcarrier signals. The number of subcarrier signals included in each subset may be the same or different. Here, when a signal S(f) mapped onto a subcarrier f with a frequency f belongs to a subset #k, a signal S′(f) that has undergone a phase rotation process in the transmission phase rotation unit 114 is represented by formula (1) below. The range of k is k∈0, . . . , K−1.

$$\begin{matrix}Formula 1 & \\ {S}^{′} ( f ) = exp \{ j ( \frac{2 π fk}{DK} + {ϕ}_{k} ) \} \cdot S ( f ) & ( 1 )\end{matrix}$$

In formula (1), Φₖ is the phase offset of the subset #k. The process with formula (1) means that phase rotation is performed so that each subset has a different time-peak timing, while allowing an event of in-phase combination for each subset. Thus, the transmission phase rotation unit 114 can evenly distribute time timings of in-phase combination for each subset. As described above, when M is the number of subcarrier signal sequences replicated by the subcarrier mapping unit 113, D is the subcarrier spacing, K is the number of divided subsets, and the signal S(f) mapped onto the subcarrier f with the frequency f belongs to the subset #k, the transmission phase rotation unit 114 performs the phase rotation process represented by formula (1) on the signal S(f) and outputs the signal S′(f).

Next, a description is given of a process in the reception phase rotation unit 214 included in the reception baseband processing unit 210 of the receiving apparatus 20, which is a feature of the present embodiment, in the communication system 1 to which frequency repetition is applied in the present embodiment. The reception phase rotation unit 214 performs a process to compensate for the phase rotations in the transmission phase rotation unit 114 included in the transmission baseband processing unit 110 of the transmitting apparatus 10 described above, to return the phase-rotated signals to the signals in the states before being phase-rotated. That is, the reception phase rotation unit 214 performs phase rotation inverse to the phase rotation of formula (1). The reception phase rotation unit 214 performs a phase rotation process represented by formula (2) below on a reception signal R(f) of the subcarrier f that is the output of the DFT unit 215 when the reception signal R(f) belongs to the subset #k, and obtains a signal R′(f) to be an output signal.

$$\begin{matrix}Formula 2 & \\ {R}^{′} ( f ) = exp \{ - j ( \frac{2 π fk}{DK} + {ϕ}_{k} ) \} \cdot R ( f ) & ( 2 )\end{matrix}$$

Thus, when M is the number of subcarrier signal sequences replicated in the transmitting apparatus 10, D is the subcarrier spacing when the subcarrier signal sequences replicated in the transmitting apparatus 10 are mapped at equal intervals with the subcarrier spacing, K is the number of subsets included in one subcarrier signal sequence when each subcarrier signal sequence is divided into subsets in the transmitting apparatus 10, and the reception signal R(f) of the subcarrier f with the frequency f belongs to the subset #k, the reception phase rotation unit 214 performs the phase rotation process represented by formula (2) on the reception signal R(f) and outputs the signal R′(f).

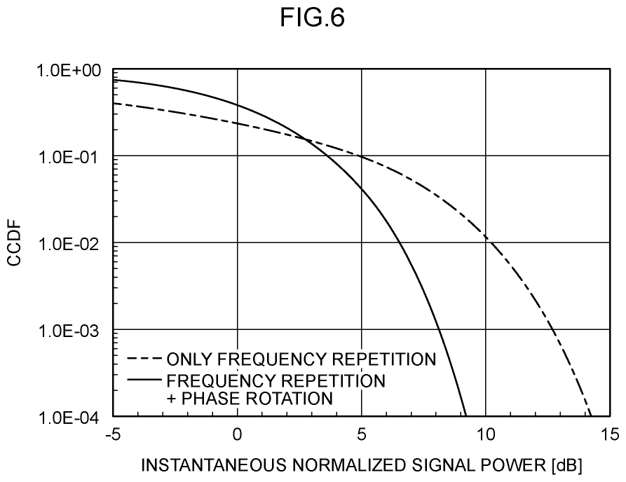

FIG. 6 is a diagram illustrating an example of the complementary cumulative distribution function characteristics of instantaneous normalized signal power obtained by the communication system 1 according to the first embodiment. To show the effect of the phase rotation performed by the communication system 1 of the present embodiment, FIG. 6 illustrates the complementary cumulative distribution function, that is, the CCDF of instantaneous normalized signal power at the time of transmission of the transmitting apparatus 10 determined by computer simulation. The computer simulation uses frequency repetition in which the number of IDFT points N=256, the length of a subcarrier signal sequence L=56, the number of replications of the subcarrier signal sequence M=4, and the subcarrier spacing of replicated subcarrier signal sequences D=64. The subset division number K=7 is used, and the phase rotation provided with formula (1) is applied. The primary modulation scheme is quadrature phase-shift keying (QPSK).

In FIG. 6, the power value at CCDF=10⁻³ is defined as the PAPR. It has been confirmed that when QPSK is used as primary modulation, the transmission signal waveform of normal OFDM communication to which frequency repetition is not applied is PAPR=8.1 dB. When frequency repetition is applied, in-phase combination of the number of replications of the subcarrier signal sequence M=4 replicated signals occurs, and thus the PAPR is degraded to PAPR=12.6 dB. In contrast, when phase rotation for each subset is applied while frequency repetition is applied as in the present embodiment, it can be confirmed that the PAPR becomes equal to 8.1 dB equivalent to that in normal OFDM communication. That is, by applying phase rotation for each subset while applying frequency repetition as in the present embodiment, the PAPR can be improved by 4.5 dB as compared with the case where only frequency repetition is applied. This is an effect provided by performing phase rotation in the frequency domain so that each subset has a different time-peak timing, while allowing an event of in-phase combination of time signals for each subset as described above.

As an operation of the communication system 1, the operation of the receiving apparatus 20 is performed after the operation of the transmitting apparatus 10. Therefore, although not described with a flowchart, the operation of the communication system 1 can be described in a flow in which the operation of the receiving apparatus 20 illustrated in the flowchart of FIG. 3 is performed after the operation of the transmitting apparatus 10 illustrated in the flowchart of FIG. 2.

Next, a hardware configuration of the transmitting apparatus 10 will be described. In the transmitting apparatus 10, the transmission RF unit 120 is a typical RF module circuit. The transmitting antenna 130 is an antenna element. The transmission baseband processing unit 110 is implemented by processing circuitry. The processing circuitry may be a processor to execute a program stored in memory and the memory, or may be dedicated hardware. The processing circuitry is also referred to as a control circuit.

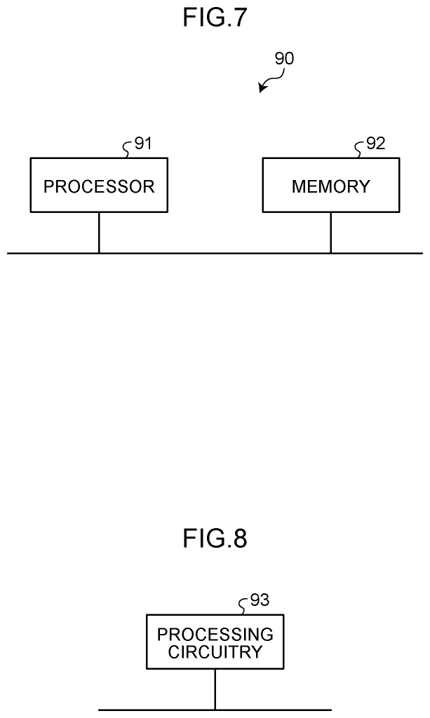

FIG. 7 is a diagram illustrating an exemplary configuration of processing circuitry 90 in the case where a processor 91 and a memory 92 constitute processing circuitry that implements the transmitting apparatus 10 according to the first embodiment. The processing circuitry 90 illustrated in FIG. 7 is a control circuit and includes the processor 91 and the memory 92. When the processor 91 and the memory 92 constitute the processing circuitry 90, functions of the processing circuitry 90 are implemented by software, firmware, or a combination of software and firmware. The software or firmware is described as a program and stored in the memory 92. In the processing circuitry 90, the processor 91 reads and executes the program stored in the memory 92, thereby implementing each function. That is, the processing circuitry 90 includes the memory 92 for storing the program that results in the execution of processing in the transmitting apparatus 10. This program can be said to be a program for causing the transmitting apparatus 10 to perform the functions implemented by the processing circuitry 90. This program may be provided via a storage medium on which the program is stored, or may be provided via another means such as a communication medium.

The program can be said to be a program that causes the transmitting apparatus 10 to perform a subcarrier mapping step in which the subcarrier mapping unit 113 replicates a subcarrier signal sequence and maps a plurality of the replicated subcarrier signal sequences at equal intervals with the subcarrier spacing D, and a transmission phase rotation step in which the transmission phase rotation unit 114 divides each subcarrier signal sequence mapped with the subcarrier spacing D into two or more subsets and applies a phase rotation that results in a different time timing to each subset.

Here, the processor 91 is, for example, a central processing unit (CPU), a processing device, an arithmetic device, a microprocessor, a microcomputer, a digital signal processor (DSP), or the like. The memory 92 corresponds, for example, to nonvolatile or volatile semiconductor memory such as random-access memory (RAM), read-only memory (ROM), flash memory, an erasable programmable ROM (EPROM), or an electrically EPROM (EEPROM) (registered trademark), or a magnetic disk, a flexible disk, an optical disk, a compact disc, a mini disc, a digital versatile disc (DVD), or the like.

FIG. 8 is a diagram illustrating an example of processing circuitry 93 in the case where dedicated hardware constitutes processing circuitry that implements the transmitting apparatus 10 according to the first embodiment. The processing circuitry 93 illustrated in FIG. 8 corresponds, for example, to a single circuit, a combined circuit, a programmed processor, a parallel-programmed processor, an application-specific integrated circuit (ASIC), a field-programmable gate array (FPGA), or a combination thereof. The processing circuitry may be implemented partly by dedicated hardware and partly by software or firmware. Thus, the processing circuitry can implement the above-described functions with dedicated hardware, software, firmware, or a combination thereof.

The hardware configuration of the transmitting apparatus 10 has been described. A hardware configuration of the receiving apparatus 20 is the same. In the receiving apparatus 20, the reception RF unit 220 is a typical RF module circuit. The receiving antenna 230 is an antenna element. The reception baseband processing unit 210 is implemented by processing circuitry. The processing circuitry may be a processor to execute a program stored in memory and the memory, or may be dedicated hardware. The processing circuitry is also referred to as a control circuit.

As described above, according to the present embodiment, in the communication system 1, the transmission phase rotation unit 114 of the transmitting apparatus 10 divides each subcarrier signal sequence mapped with the subcarrier spacing D into two or more subsets, and applies a phase rotation that results in a different time timing to each subset. Specifically, in the case where frequency repetition is applied in which a subcarrier signal sequence with the length L is replicated M times and the M subcarrier signal sequences are distributed and mapped at equal intervals with the subcarrier spacing D, the transmission phase rotation unit 114 divides each subcarrier signal sequence into K subsets, and applies a phase rotation that results in a different time timing to each subset so as to evenly distribute time timings between the subsets. The reception phase rotation unit 214 of the receiving apparatus 20 inversely rotates the phases for the received subcarrier signal sequences by the amounts of the phase rotations applied by the transmission phase rotation unit 114 of the transmitting apparatus 10, to compensate for the phase rotations in the transmitting apparatus 10. Consequently, the communication system 1 can prevent a decrease in transmission power efficiency while preventing degradation of the peak-to-average power ratio of a transmission waveform in the case where frequency repetition is applied to OFDM communication.

### Second Embodiment

The first embodiment has described the case where the transmitting apparatus 10 and the receiving apparatus 20 perform wireless communication. A second embodiment describes a case where a transmitting apparatus and a receiving apparatus perform wired communication.

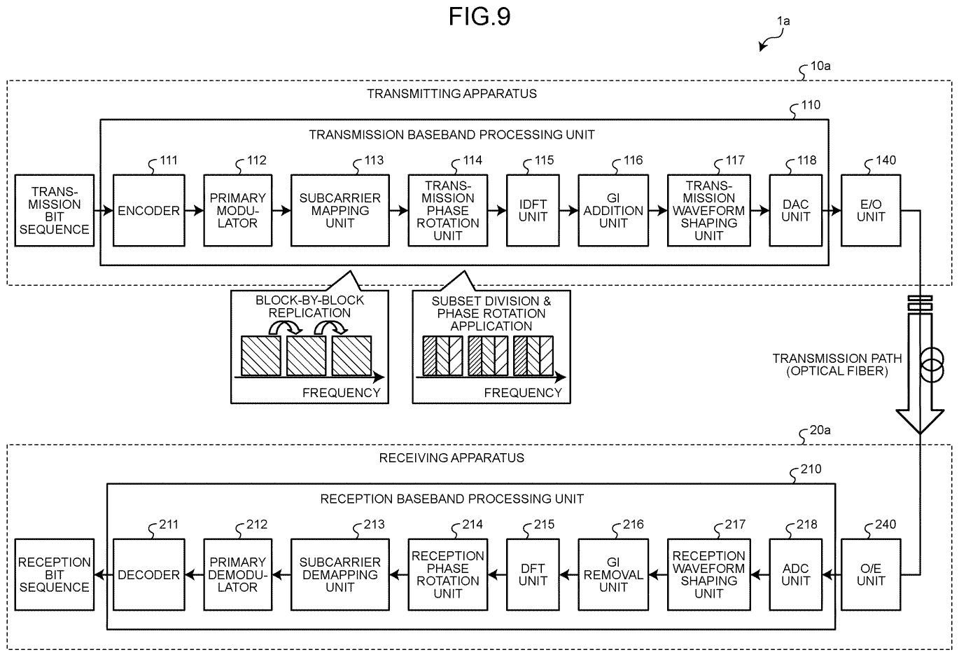

FIG. 9 is a diagram illustrating an exemplary configuration of a communication system 1a according to the second embodiment. The communication system 1a includes a transmitting apparatus 10a and a receiving apparatus 20a. The communication system 1a is a system in which the transmitting apparatus 10a and the receiving apparatus 20a perform wired communication, which is optical communication through an optical fiber in the example of FIG. 9, using OFDM communication to which frequency repetition is applied. Although FIG. 9 illustrates an example in which the communication system 1a includes the single transmitting apparatus 10a and the single receiving apparatus 20a, which is not limiting. The communication system 1a may include a plurality of the transmitting apparatuses 10a and a plurality of the receiving apparatuses 20a.

The transmitting apparatus 10a includes the transmission baseband processing unit 110 and an electrical-to-optical (E/O) unit 140 that performs electrical-to-optical conversion. The process details of the transmission baseband processing unit 110 of the second embodiment are the same as the process details of the transmission baseband processing unit 110 described in the first embodiment. The E/O unit 140 converts a baseband signal generated by the transmission baseband processing unit 110 from an electrical signal into an optical signal, and outputs the optical signal to a transmission path, which is the optical fiber in the example of FIG. 9.

The receiving apparatus 20a includes an optical-to-electrical (O/E) unit 240 that performs optical-to-electrical conversion and the reception baseband processing unit 210. The O/E unit 240 converts a reception signal acquired through the transmission path, which is the optical fiber in the example of FIG. 9, from the optical signal into an electrical signal, and outputs the electrical signal to the reception baseband processing unit 210. The process details of the reception baseband processing unit 210 of the second embodiment are the same as the process details of the reception baseband processing unit 210 described in the first embodiment.

Even when the communication system 1a performs wired communication with the configuration illustrated in FIG. 9, the communication system 1a can provide the same effects as those of the communication system 1 of the first embodiment.

The transmitting apparatus according to the present disclosure has an effect of being able to prevent a decrease in transmission power efficiency while preventing degradation of the peak-to-average power ratio of a transmission waveform in the case where frequency repetition is applied to OFDM communication.

The configurations described in the above embodiments illustrate an example, and can be combined with another known art. The embodiments can be combined with each other. The configurations can be partly omitted or changed without departing from the gist.

What is claimed is:

1. A transmitting apparatus to perform Orthogonal Frequency Division Multiplexing communication, the transmitting apparatus comprising:
subcarrier mapping circuitry to replicate a subcarrier signal sequence and map a plurality of the replicated subcarrier signal sequences at equal intervals with a subcarrier spacing; and
transmission phase rotation circuitry to divide each of the subcarrier signal sequences mapped with the subcarrier spacing into two or more subsets and apply a phase rotation that results in a different time timing to each of the subsets, wherein
M and D are integers greater than or equal to one, K is an integer greater than or equal to two, and a range of k is k∈0, . . . , K−1, and
when M is the number of the subcarrier signal sequences replicated by the subcarrier mapping circuitry, D is the subcarrier spacing, K is the number of the divided subsets, a signal S(f) mapped onto a subcarrier f with a frequency f belongs to a subset #k, and Φₖ is a phase offset of the subset #k, the transmission phase rotation circuitry performs a phase rotation process represented by a following formula on the signal S(f) and outputs a signal S′(f).
$$\begin{matrix}Formula 1 & \\ {S}^{′} ( f ) = exp \{ j ( \frac{2 π fk}{DK} + {ϕ}_{k} ) \} \cdot S ( f ) & ( 1 )\end{matrix}$$

2. A receiving apparatus to receive subcarrier signal sequences transmitted from a transmitting apparatus to perform Orthogonal Frequency Division Multiplexing communication, the receiving apparatus comprising:
reception phase rotation circuitry to inversely rotate phases for the received subcarrier signal sequences by amounts of phase rotations applied in the transmitting apparatus to compensate for the phase rotations in the transmitting apparatus; and
subcarrier demapping circuitry to combine the subcarrier signal sequences whose phase rotations have been compensated for by the reception phase rotation circuitry to extract the combined subcarrier signal sequences as a demodulation signal, wherein
M and D are integers greater than or equal to one, K is an integer greater than or equal to two, and a range of k is k∈0, . . . , K−1, and
when M is the number of the subcarrier signal sequences replicated in the transmitting apparatus, D is a subcarrier spacing when the subcarrier signal sequences replicated in the transmitting apparatus are mapped at equal intervals with the subcarrier spacing, K is the number of subsets included in one subcarrier signal sequence when each of the subcarrier signal sequences is divided into the subsets in the transmitting apparatus, a reception signal R(f) of a subcarrier f with a frequency f belongs to a subset #k, and Φₖ is a phase offset of the subset #k, the reception phase rotation circuitry performs a phase rotation process represented by a following formula on the reception signal R(f) and outputs a signal R′(f).
$$\begin{matrix}Formula 2 & \\ {R}^{′} ( f ) = exp \{ - j ( \frac{2 π fk}{DK} + {ϕ}_{k} ) \} \cdot R ( f ) & ( 2 )\end{matrix}$$

3. A communication system comprising a transmitting apparatus to perform Orthogonal Frequency Division Multiplexing communication and a receiving apparatus, wherein
the transmitting apparatus includes
subcarrier mapping circuitry to replicate a subcarrier signal sequence and map a plurality of the replicated subcarrier signal sequences at equal intervals with a subcarrier spacing, and
transmission phase rotation circuitry to divide each of the subcarrier signal sequences mapped with the subcarrier spacing into two or more subsets and apply a phase rotation that results in a different time timing to each of the subsets, and
the receiving apparatus includes
reception phase rotation circuitry to inversely rotate phases for the received subcarrier signal sequences by amounts of the phase rotations applied in the transmitting apparatus to compensate for the phase rotations in the transmitting apparatus, and
subcarrier demapping circuitry to combine the subcarrier signal sequences whose phase rotations have been compensated for by the reception phase rotation circuitry to extract the combined subcarrier signal sequences as a demodulation signal, wherein
M and D are integers greater than or equal to one, K is an integer greater than or equal to two, and a range of k is k∈0, . . . , K−1, and
when M is the number of the subcarrier signal sequences replicated by the subcarrier mapping circuitry, D is the subcarrier spacing, K is the number of the divided subsets, a signal S(f) mapped onto a subcarrier f with a frequency f belongs to a subset #k, and Φₖ is a phase offset of the subset #k, the transmission phase rotation circuitry performs a phase rotation process represented by a following formula on the signal S(f) and outputs a signal S′(f).
$$\begin{matrix}Formula 3 & \\ {S}^{′} ( f ) = exp \{ j ( \frac{2 π fk}{DK} + {ϕ}_{k} ) \} \cdot S ( f ) & ( 3 )\end{matrix}$$

4. The communication system according to claim 3, wherein
M and D are integers greater than or equal to one, K is an integer greater than or equal to two, and a range of k is k∈0, . . . , K−1, and
when M is the number of the subcarrier signal sequences replicated in the transmitting apparatus, D is the subcarrier spacing when the subcarrier signal sequences replicated in the transmitting apparatus are mapped at equal intervals with the subcarrier spacing, K is the number of the subsets included in one subcarrier signal sequence when each of the subcarrier signal sequences is divided into the subsets in the transmitting apparatus, a reception signal R(f) of a subcarrier f with a frequency f belongs to a subset #k, and Φₖ is a phase offset of the subset #k, the reception phase rotation circuitry performs a phase rotation process represented by a following formula on the reception signal R(f) and outputs a signal R′(f).
$$\begin{matrix}Formula 4 & \\ {R}^{′} ( f ) = exp \{ - j ( \frac{2 π fk}{DK} + {ϕ}_{k} ) \} \cdot R ( f ) & ( 4 )\end{matrix}$$
